(19) United States
(12) Patent Application Publication
(10) Pub. No.: US 2021/0010407 A1
(43) Pub. Date: Jan. 14, 2021

(54) REDUCTANT DELIVERY CONDUIT FOR A REDUCTANT STORAGE TANK

(71) Applicant: Cummins Emission Solutions Inc., Columbus, IN (US)

(72) Inventors: Tushar Tej Dandu, Columbus, IN (US); David E. Shreve, Franklin, IN (US); Sriram Narayanasamy, Greenwood, IN (US)

(73) Assignee: Cummins Emission Solutions Inc., Columbus, IN (US)

(21) Appl. No.: 16/977,224

(22) PCT Filed: Mar. 5, 2019
(86) PCT No.: PCT/US19/20728

§ 371 Date: Sep. 1, 2020

Related U.S. Application Data
(60) Provisional application No. 62/639,287, filed on Mar. 6, 2018.

(51) Int. Cl. F01N 3/20; B01D 53/94

(52) U.S. Cl. CPC F01N 3/2066; B01D 53/9418; B01D 53/9431; F01N 2610/02; F01N 2610/1486; F01N 2610/1453; F01N 2610/1406

(57) ABSTRACT

An apparatus comprises a reductant storage tank configured to store a reductant, and a reductant delivery conduit. A first end of the reductant delivery conduit is fluidly coupled to the reductant storage tank. A second end of the reductant delivery conduit opposite the first end is configured to be fluidly coupled to a connector of a reductant insertion assembly. At least one bend having a bend angle is provided in the reductant delivery conduit along a length thereof, the at least one bend being configured to inhibit failure at an interface between the second end of the reductant delivery conduit and the connector of the reductant insertion assembly due to freezing of a reductant in the reductant delivery conduit.

### CROSS-REFERENCE TO RELATED APPLICATIONS

This application claims priority to U.S. Provisional Patent Application No. 62/639,287 filed on Mar. 6, 2018, which is herein incorporated by reference in its entirety.

### TECHNICAL FIELD

The present disclosure relates generally to aftertreatment systems for use with internal combustion (IC) engines.

### BACKGROUND

Exhaust aftertreatment systems are used to receive and treat exhaust gas generated by IC engines. Generally, exhaust gas aftertreatment systems comprise any of several different components to reduce the levels of harmful exhaust emissions present in exhaust gas. For example, certain exhaust gas aftertreatment systems for diesel-powered IC engines comprise a selective catalytic reduction (SCR) system, including a catalyst formulated to convert NOx (NO and NO₂ in some fraction) into harmless nitrogen gas (N₂) and water vapor (H₂O) in the presence of ammonia (NH₃). Generally, in such aftertreatment systems, an exhaust reductant (e.g., a diesel exhaust fluid such as urea) is injected into the SCR system to provide a source of ammonia and mixed with the exhaust gas to partially reduce the NOx gases. The reduction byproducts of the exhaust gas are then fluidly communicated to the catalyst included in the SCR system to decompose substantially all of the NOx gases into relatively harmless byproducts that are expelled out of the aftertreatment system.

Aftertreatment systems may include a reductant storage tank for storing the reductant. Conventional aftertreatment systems include a straight reductant delivery conduit fluidly coupled to the reductant storage tank. The straight reductant delivery conduit may be used to pull the reductant out of the reductant storage tank (e.g., via suction) by a reductant insertion assembly. The reductant delivery conduit is fluidly coupled to a connector of the reductant insertion assembly. The connector may be formed from a relatively weak material, such as plastic.

The reductant may include an aqueous urea solution, for example, containing 32.5 w/w % urea and 67.5 w/w % water. In cold ambient conditions, for example, when an ambient temperature is below −11 degrees Celsius, the reductant freezes and expands (e.g., between 7-10%) in the reductant delivery conduit. This causes the reductant to exert a vertical force on the connector of the reductant insertion assembly at the interface with the straight reductant delivery conduit. The reductant in the reductant storage tank may also freeze from edges of the reductant in the reductant storage tank followed by freezing of the bulk of the reductant towards the center of the reductant storage tank. This exerts a further force on the portion of the reductant already frozen in the straight reductant delivery conduit. This causes an even larger force to be exerted on the connector of the reductant insertion assembly. The force may be substantial and damage to the connector (e.g., produce cracks), which may lead to leakage of the reductant at the interface between the straight reductant delivery conduit and the connector after the reductant thaws.

### SUMMARY

Embodiments described herein relate generally to systems and methods for inhibiting failure of a connector of a reductant insertion assembly due to freezing of a reductant in a reductant delivery conduit. In particular, embodiments described herein provide for a reductant delivery conduit having a bend provided therein, the bend configured to cause a reduction in force exerted on the connector coupled to the reductant delivery conduit due to freezing and expansion of the reductant therein relative to a straight reductant delivery conduit.

In one embodiment, an apparatus includes a reductant storage tank configured to store a reductant and a reductant delivery conduit. The reductant delivery conduit includes a first end fluidly coupled to the reductant storage tank. The reductant delivery conduit includes a second end opposite the first end. The second end is configured to be fluidly coupled to a connector of a reductant insertion assembly. The apparatus further includes at least one bend provided in the reductant delivery conduit along a length thereof, the at least one bend being configured to inhibit failure at an interface between the second end of the reductant delivery conduit and the connector of the reductant insertion assembly due to freezing of a reductant in the reductant delivery conduit.

In one aspect of the apparatus, the reductant delivery conduit includes a reductant delivery conduit first portion fluidly coupled to the reductant storage tank at the first end. The reductant delivery conduit includes a reductant delivery conduit second portion configured to be fluidly coupled to the connector at the second end. The reductant delivery conduit includes a reductant delivery conduit connector fluidly coupling the reductant delivery conduit first portion to the reductant delivery conduit second portion. The reductant delivery conduit connector comprises the at least one bend.

In one aspect of the apparatus, a cross-sectional thickness of the reductant delivery conduit connector is greater than a cross-sectional thickness of the reductant deliver conduit.

In one aspect of the apparatus, a length of the reductant delivery conduit first portion is greater than a length of the reductant delivery conduit second portion.

In one aspect of the apparatus, the reductant delivery conduit includes exactly one bend.

In one aspect of the apparatus, a bend angle of the at least one bend is in a range of 80 degrees to 100 degrees.

In one aspect of the apparatus, the at least one bend comprises a plurality of bends.

In one aspect of the apparatus, the at least one bend is monolithically formed in the reductant delivery conduit.

In one aspect of the apparatus, the at least one bend has a bend radius of less than 8.5 mm.

In one aspect of the apparatus, a length of the reductant delivery conduit between the at least one bend of the reductant delivery conduit and the second end of the reductant delivery conduit is greater than 10 mm.

One embodiment relates to a method for preventing failure in an aftertreatment system. The method includes providing a reductant storage tank configured to store a reductant. The method includes providing a reductant delivery conduit comprising at least one bend provided in the reductant delivery conduit along a length thereof. The method includes coupling a first end the reductant delivery conduit to the reductant storage tank. The method includes coupling a second end of the reductant delivery conduit to a connector of a reductant insertion assembly. The at least one bend is configured to inhibit failure at an interface between the second end of the reductant delivery conduit and the connector of the reductant insertion assembly due to freezing of a reductant in the reductant delivery conduit.

In one aspect of the method, the reductant delivery conduit further includes a reductant delivery conduit first portion fluidly coupled to the reductant storage tank via the first end when the first end of the reductant delivery conduit is coupled to the reductant storage tank. The reductant delivery conduit includes a reductant delivery conduit second portion fluidly coupled to the connector via the second end when the second end of the reductant delivery conduit is coupled to the connector of the reductant insertion assembly. The reductant delivery conduit includes a reductant delivery conduit connector fluidly coupling the reductant delivery conduit first portion to the reductant delivery conduit second portion, the at least one bend being provided in the reductant delivery conduit connector.

In one aspect of the method, a cross-sectional thickness of the reductant delivery conduit connector is greater than a cross-sectional thickness of the reductant deliver conduit.

In one aspect of the method, a length of the reductant delivery conduit first portion is greater than a length of the reductant delivery conduit second portion.

In one aspect of the method, the reductant delivery conduit includes exactly one bend.

In one aspect of the method, a bend angle of the at least one bend is in a range of 80 degrees to 100 degrees.

In one aspect of the method, the at least one bend comprises a plurality of bends.

In one aspect of the method, the at least one bend is monolithically formed in the reductant delivery conduit.

In one aspect of the method, the at least one bend has a bend radius of less than 8.5 mm.

In one aspect of the method, a length of the reductant delivery conduit between the at least one bend of the reductant delivery conduit and the second end of the reductant delivery conduit is greater than 10 mm.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

The foregoing and other features of the present disclosure will become more fully apparent from the following description and appended claims taken in conjunction with the accompanying drawings. Understanding that these drawings depict only several implementations in accordance with the disclosure and are therefore not to be considered limiting of its scope, the disclosure will be described with additional specificity and detail through use of the accompanying drawings.

FIG. 1 is a schematic illustration of an aftertreatment system, according to an embodiment.

FIGS. 2A-2C show various embodiments of a reductant delivery conduit that may be used in the aftertreatment system of FIG. 1.

FIG. 3 is a schematic illustration of reductant delivery conduit having a reductant delivery conduit first portion positioned on a reductant storage tank cap, a reductant delivery conduit second portion coupled to the reductant delivery conduit first portion via a reductant delivery conduit connector which as a bend provided therein, according to a particular embodiment.

FIG. 4A shows a conventional straight reductant delivery conduit coupled to a connector of a reductant insertion assembly, and a plot of the force exerted at an interface between the straight reductant delivery conduit and the connector due to the freezing of the reductant therein; FIG. 4B shows a reductant delivery conduit having a bend provided therein, coupled to the connector of FIG. 4A, and a plot of the force exerted at an interface between the bent reductant delivery conduit and the connector due to the freezing of the reductant therein.

FIG. 5 is a schematic flow diagram of a method for reducing a force exerted due to expansion of a reductant in a reductant delivery conduit because of the reductant freezing, according to various embodiments.

FIG. 6A shows a reductant delivery conduit having a bend provided therein and a graph of the reaction force vs. bend radius. FIG. 6B shows a reductant delivery conduit having a bend provided therein and a graph of the reaction force vs. length of reductant delivery conduit second portion.

Reference is made to the accompanying drawings throughout the following detailed description. In the drawings, similar symbols typically identify similar components unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for preventing failure of a connector a reductant insertion assembly due to freezing of a reductant in a reductant delivery conduit. In particular, embodiments described herein provide for a reductant delivery conduit having a bend provided therein, the bend configured to cause a reduction in force exerted on the connector coupled to the reductant delivery conduit due to freezing and expansion of the reductant therein relative to a straight reductant delivery conduit.

Aftertreatment systems may include a reductant storage tank for storing the reductant. Conventional aftertreatment systems include a straight reductant delivery conduit fluidly coupled to the reductant storage tank. The straight reductant delivery conduit may be used to pull the reductant out of the reductant storage tank (e.g., via suction) by a reductant insertion assembly. The reductant delivery conduit is fluidly coupled to a connector of the reductant insertion assembly. The connector may be formed from a relatively weak material, such as plastic.

The reductant may include an aqueous urea solution, for example, containing 32.5 w/w % urea and 67.5 w/w % water. In cold ambient conditions, for example, when an ambient temperature is below −11 degrees Celsius. The reductant freezes and expands (e.g., between 7-10%) in the reductant delivery conduit. This causes the reductant to exert a vertical force on the connector of the reductant insertion assembly at the interface with the straight reductant delivery conduit. The reductant in the reductant storage tank may also freeze from edges of the reductant in the reductant storage tank followed by freezing of the bulk of the reductant towards the center of the reductant storage tank. This exerts a further force on the portion of the reductant already frozen in the straight reductant delivery conduit. This causes an even larger force to be exerted on the connector of the reductant insertion assembly. The force may be substantially large so as to damage to the connector (e.g., produce cracks), which may lead to leakage of the reductant at the interface between the straight reductant delivery conduit and the connector after the reductant thaws. This causes the reductant to exert a vertical force on the connector of the reductant insertion assembly at the interface with the straight reductant delivery conduit.

The reductant in the reductant storage tank may also freeze progressively starting from edges of the reductant in the reductant storage tank towards the bulk of the reductant in the center of the reductant storage tank. This exerts a further force on the portion of the reductant already frozen in the straight reductant delivery conduit, therefore exerting an even larger force on the connector of the reductant insertion assembly. The force may be substantially large so as to damage the connector (e.g., crack formation) and leading to leakage of the reductant at the interface between the straight reductant delivery conduit and the connector after the reductant thaws. This may be particularly problematic in systems that do not include a reductant return line or other mechanism for returning any reductant remaining in the straight reductant delivery conduit after the aftertreatment system is shut OFF (e.g., an engine fluidly coupled to the aftertreatment system and producing an exhaust gas is turned OFF).

Various embodiments of the systems and methods described herein may provide benefits including, for example: (1) reducing a force exerted by freezing and expansion of a reductant in a reductant delivery conduit on an interface between the reductant delivery conduit and a connector of a reductant insertion assembly by providing a bend in the reductant delivery conduit; (2) providing a cheap and simple drop in solution by simply replacing conventional straight reductant delivery conduit with the bent reductant delivery conduit of the present application; and (3) preventing or substantially reducing possibility of failure of a reductant insertion assembly connector, thereby reducing maintenance frequency and cost.

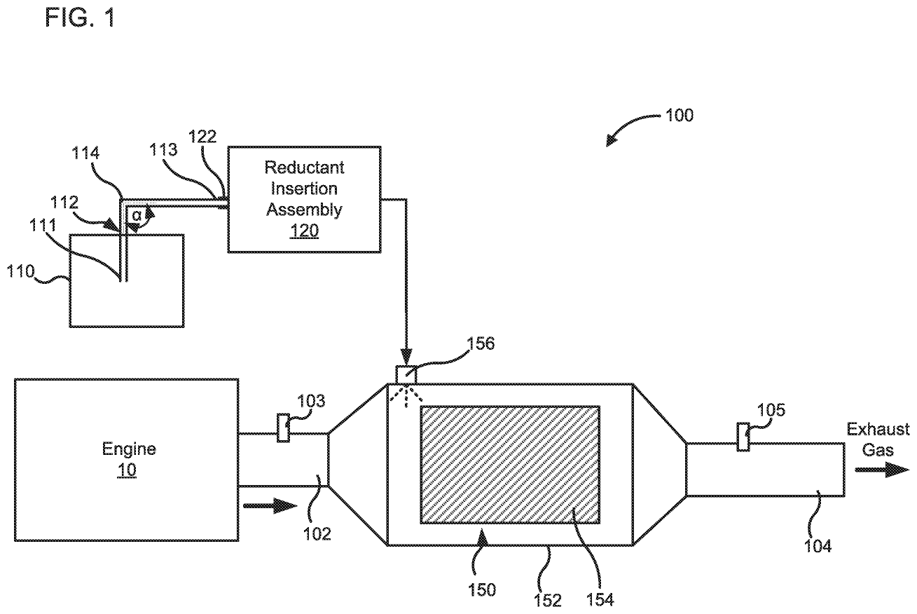

FIG. 1 is a schematic illustration of an aftertreatment system 100, according to an embodiment. The aftertreatment system 100 is configured to receive an exhaust gas (e.g., a diesel exhaust gas) from an engine 10 (e.g., a diesel engine, a dual fuel engine, etc.) and reduce constituents of the exhaust gas such as, for example, NOx gases, CO, hydrocarbons, etc. The aftertreatment system 100 may comprise a reductant storage tank 110, a reductant delivery conduit 112, a reductant insertion assembly 120 and an SCR system 150. In some embodiments, the aftertreatment system 100 may also comprise a controller 170.

The SCR system 150 comprises a housing 152 defining an internal volume within which the catalyst 154 structured to decompose constituents of an exhaust flowing therethrough, is positioned. The housing 152 may be formed from a rigid, heat-resistant and corrosion-resistant material, for example stainless steel, iron, aluminum, metals, ceramics, or any other suitable material. The housing 152 may have any suitable cross-section, for example circular, square, rectangular, oval, elliptical, polygonal, or any other suitable shape.

In some embodiments, the SCR system 150 may comprise a selective catalytic reduction filter (SCRF) system, or any other aftertreatment component, configured to decompose constituents of the exhaust gas (e.g., NOx gases such as such nitrous oxide, nitric oxide, nitrogen dioxide, etc.), flowing through the aftertreatment system 100 in the presence of a reductant, as described herein.

Although FIG. 1 shows only the catalyst 154 positioned within the internal volume defined by the housing 152, in other embodiments, a plurality of aftertreatment components may be positioned within the internal volume defined by the housing 152 in addition to or in place of the SCR system 150. Such aftertreatment components may comprise, for example, filters (e.g., particulate matter filters, catalyzed filters, etc.), oxidation catalysts (e.g., carbon monoxide, hydrocarbons and/or ammonia oxidation catalysts), mixers, baffle plates, or any other suitable aftertreatment component.

An inlet conduit 102 is fluidly coupled to an inlet of the housing 152 and structured to receive exhaust gas from an engine 10 (e.g., a diesel engine, a gasoline engine, a biodiesel engine, an E85 engine, a natural gas engine, a dual fuel engine, etc.) and to communicate the exhaust gas to an internal volume defined by the housing 152. Furthermore, an outlet conduit 104 may be coupled to an outlet of the housing 152 and structured to expel treated exhaust gas into the environment.

A first sensor 103 may be positioned in the inlet conduit 102. The first sensor 103 may comprise a NOx sensor, for example a physical or virtual NOx sensor, configured to determine an amount of NOx gases included in the exhaust gas being emitted by the engine 10. In various embodiments, an oxygen sensor, a temperature sensor, a pressure sensor, or any other sensor may also be positioned in the inlet conduit 102 so as to determine one or more operational parameters of the exhaust gas flowing through the aftertreatment system 100.

A second sensor 105 may be positioned in the outlet conduit 104. The second sensor 105 may comprise a second NOx sensor configured to determine an amount of NOx gases expelled into the environment after passing through the SCR system 150. In other embodiments, the second sensor 105 may comprise an ammonia oxide (AMOx) sensor configured to determine an amount of ammonia in the exhaust gas downstream of the SCR system 150 so as to determine an ammonia slip of the catalyst 154. The ammonia slip may be used to adjust an amount of reductant to be inserted into the SCR system 150 by the reductant insertion assembly 120.

A reductant insertion port 156 may be provided on a sidewall of housing 152 and structured to allow insertion of a reductant therethrough into the internal volume defined by the housing 152. The reductant insertion port 156 may be positioned upstream of the catalyst 154 (e.g., to allow reductant to be inserted into the exhaust gas upstream of the catalyst 154) or over the catalyst 154 (e.g., to allow reductant to be inserted directly on the catalyst 154). In other embodiments, the reductant insertion port 156 may be disposed on the inlet conduit 102 and configured to insert the reductant into the inlet conduit 102 upstream of the SCR system 150. In such embodiments, mixers, baffles, vanes or other structures may be positioned in the inlet conduit 102 so as to facilitate mixing of the reductant with the exhaust gas.

The catalyst 154 is formulated to selectively decompose constituents of the exhaust gas. Any suitable catalyst can be used such as, for example, platinum, palladium, rhodium, cerium, iron, manganese, copper, vanadium based catalyst, any other suitable catalyst, or a combination thereof. The catalyst 154 can be disposed on a suitable substrate such as, for example, a ceramic (e.g., cordierite) or metallic (e.g., kanthal) monolith core which can, for example, define a honeycomb structure. A washcoat can also be used as a carrier material for the catalyst 154. Such washcoat materials may comprise, for example, aluminum oxide, titanium dioxide, silicon dioxide, any other suitable washcoat material, or a combination thereof. The exhaust gas (e.g., diesel exhaust gas) can flow over and/or about the catalyst 154 such that any NOx gases included in the exhaust gas are further reduced to yield an exhaust gas which is substantially free of NOx gases.

The reductant storage tank 110 is structured to store a reductant. The reductant storage tank 110 may include a reductant storage tank cap through which the reductant delivery conduit 112, or other components (e.g., reductant quality sensor, reductant level sensor, temperature sensor, heating element, etc.) may be routed. The reductant is formulated to facilitate decomposition of the constituents of the exhaust gas (e.g., NOx gases included in the exhaust gas). Any suitable reductant can be used. In some embodiments, the exhaust gas comprises a diesel exhaust gas and the reductant comprises a diesel exhaust fluid. For example, the diesel exhaust fluid may comprise urea, an aqueous solution of urea, or any other fluid that comprises ammonia, by-products, or any other diesel exhaust fluid as is known in the arts (e.g., the diesel exhaust fluid marketed under the name ADBLUE®). For example, the reductant may comprise an aqueous urea solution having a particular ratio of urea to water. In particular embodiments, the reductant can comprise an aqueous urea solution including 32.5 w/w % of urea and 67.5 w/w % of deionized water, or including 40 w/w % of urea and 60 w/w % of deionize water, or any other suitable ratio of urea to deionized water. The aqueous nature of the reductant may cause it to freeze at low temperatures, for example, less than −11 degrees Celsius.

A reductant insertion assembly 120 is fluidly coupled to the reductant storage tank 110 via the reductant delivery conduit 112, which is described in further detail below. In some embodiments, the reductant insertion assembly 120 may be configured to selectively insert the reductant into the inlet conduit 102 via the reductant insertion port 156. In other embodiments, the reductant insertion assembly 120 may be configured to insert the reductant directly into the SCR system 150 (e.g., over the catalyst 154 of the SCR system 150). The reductant insertion assembly 120 may comprise various structures to facilitate receiving the reductant from the reductant storage tank 110, and delivery to the SCR system 150.

For example, the reductant insertion assembly 120 may comprise one or more pumps having filter screens (e.g., to prevent solid particles of the reductant or contaminants from flowing into the pump) and/or valves (e.g., check valves) positioned upstream thereof to receive reductant from the reductant storage tank 110. In some embodiments, the pump may comprise a diaphragm pump but any other suitable pump may be used such as, for example, a centrifugal pump, a suction pump, etc.

The pump may be configured to pressurize the reductant so as to provide the reductant to the SCR system 150 at a predetermined pressure. Screens, check valves, pulsation dampers, or other structures may also be positioned downstream of the pump to provide the reductant to the SCR system 150. In various embodiments, the reductant insertion assembly 120 may also comprise a bypass line structured to provide a return path of the reductant from the pump to the reductant storage tank 110.

A valve (e.g., an orifice valve) may be provided in the bypass line. The valve may be structured to allow the reductant to pass therethrough to the reductant storage tank 110 if an operating pressure of the reductant generated by the pump exceeds a predetermined pressure so as to prevent over pressurizing of the pump, the reductant delivery conduits, or other components of the reductant insertion assembly 120. In some embodiments, the bypass line may be configured to allow the return of the reductant to the reductant storage tank 110 during purging of the reductant insertion assembly 120 (e.g., after the aftertreatment system 100 is shut off).

In various embodiments, the reductant insertion assembly 120 may also comprise a blending chamber structured to receive pressurized reductant from a metering valve at a controllable rate. The blending chamber may also be structured to receive air, or any other inert gas (e.g., nitrogen), for example from an air supply unit so as to deliver a combined flow of the air and the reductant to the SCR system 150 through the reductant insertion port 156. In various embodiments, a nozzle may be positioned in the reductant insertion port 156 and structured to deliver a stream or a jet of the reductant into the SCR system 150.

In various embodiments, the reductant insertion assembly 120 may also comprise a dosing valve, for example positioned within a reductant delivery conduit for delivering the reductant from the reductant insertion assembly 120 to the SCR system 150. The dosing valve may comprise any suitable valve, for example a butterfly valve, a gate valve, a check valve (e.g., a tilting disc check valve, a swing check valve, an axial check valve, etc.), a ball valve, a spring loaded valve, an air assisted injector, a solenoid valve, or any other suitable valve. The dosing valve may be selectively opened to insert a predetermined quantity of the reductant for a predetermined time into the SCR system 150 or upstream therefrom. Opening and/or closing of the dosing valve may produce an audible sound (e.g., a clicking sound).

The reductant delivery conduit 112 comprises a first end 111 fluidly coupled to the reductant storage tank 110, for example, through a reductant storage tank cap of the reductant storage tank 110. A second end 113 of the reductant delivery conduit 112 opposite the first end 111 is fluidly coupled to a connector 122 of the reductant insertion assembly 120. A bend 114 is provided in the reductant delivery conduit 112. The bend 114 may be positioned proximate to the reductant storage tank 110, for example, proximate to the reductant storage tank cap of the reductant storage tank 110, and outside an internal volume defined by the reductant storage tank 110.

The bend 114 defines a bend angle α, as shown in FIG. 1. The bend angle α may be in a range of 80-100 degrees. In particular embodiment, the bend angle is 90 degrees. The bend 114 is configured to cause a reduction in a force at an interface between the second end 113 of the reductant delivery conduit 112 and the connector 122 of the reductant insertion assembly 120, the force produced by expansion of the reductant at least in the reductant delivery conduit 112 due to freezing of the reductant.

As previously described in detail herein, conventional aftertreatment systems include a straight reductant delivery conduit which exerts a large force at the interface between a connector of a reductant insertion assembly due to freezing and expansion of the reductant in the straight reductant delivery conduit and the reductant storage tank. For example, the connector 122 of the reductant insertion assembly 120 may be formed from a relatively weak material, such as plastics, which may break, crack, or otherwise leak if subjected to large force. If a straight reductant delivery conduit is used to fluidly couple the reductant storage tank 110 to the connector 122, a linear force will be exerted by the expansion of a freezing reductant in the straight reductant delivery conduit.

A large portion of the straight reductant delivery conduit may be positioned outside the reductant storage tank 110. At low temperatures (e.g., less than −11 degrees Celsius), the reductant contained in the straight reductant delivery conduit freezes first (e.g., due to smaller content of reductant contained therein relative to the reductant storage tank 110) and expands to exert a force on the connector 122. The bulk reductant in the reductant storage tank freezes thereafter exerting more force on the already frozen reductant in the straight reductant delivery conduit. The force is transmitted unimpeded to the connector 122 due to the linear structure of the straight reductant delivery conduit, and may be sufficiently large to damage the connector 122 (e.g., greater than 800 N).

In contrast, the bend 114 in the reductant delivery conduit 112 is configured to cause a reduction in a force at the interface between the second end 113 of the reductant delivery conduit 112 and the connector 122 of the reductant insertion assembly 120. For example, the bend 114 may cause the force to be distributed into a first force acting in a reductant delivery conduit first portion upstream of the bend 114 because of expansion of a first portion of the reductant in the reductant delivery conduit first portion due to freezing thereof, and because of expansion due to freezing of the reductant in the reductant storage tank 110. Furthermore, expansion due to freezing of the reductant in a reductant delivery conduit second portion downstream of the bend 114 may exert a second force on the interface between the second end 113 of the reductant delivery conduit 112 and the connector 122. The bend 114 may absorb a significant portion of the first force such that the second force acting on the connector 122 may be substantially smaller than a force that would be exerted on the connector 122, if the connector 122 were fluidly coupled to a straight reductant delivery conduit, as previously described herein.

In this manner, the bend 114 may cause a reduction in a force at an interface between the second end 113 of the reductant delivery conduit 112 and the connector 122 of the reductant insertion assembly 120 relative to a force exerted on the connector 122 due to expansion and freezing of the reductant in a straight reductant delivery conduit. In some embodiments, the reductant delivery conduit 112 provides at least a 1.5 times reduction in force relative to a straight reductant delivery conduit having no bends.

The reductant delivery conduit 112 may be formed a strong material such as, for example, metals (e.g., stainless steel, aluminum, etc.), polymers, etc. In some embodiments, a first length of the reductant delivery conduit first portion upstream of the bend 114 may be equal to a second length of the reductant delivery conduit second portion of reductant delivery conduit 112 downstream of the bend 114. In other embodiments, the reductant delivery conduit first portion may be longer than the reductant delivery conduit second portion, or vice versa.

In some embodiments, the bend 114 may be monolithically formed in the reductant delivery conduit 112. For example, the reductant delivery conduit 112 may comprise a bent tube (e.g., a straight tube which is bent along a length thereof so as to define the bend 114). In other embodiments, a reductant delivery conduit connector may be provided in the reductant delivery conduit 112 that includes the bend 114.

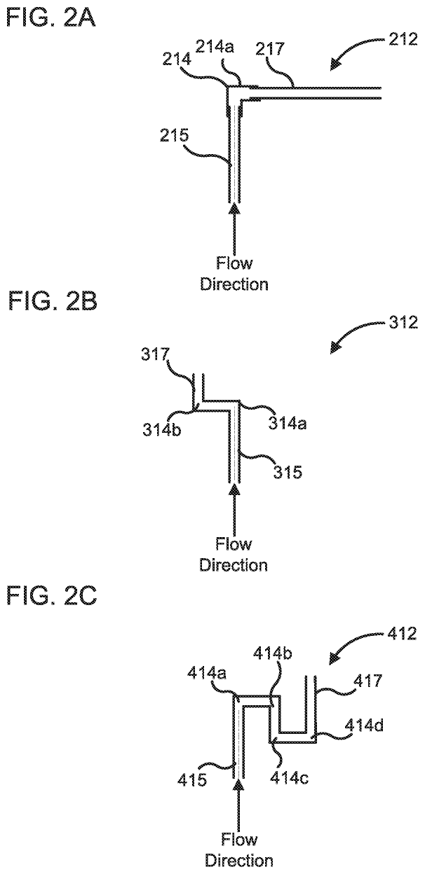

For example, FIG. 2A is a schematic illustration of a reductant delivery conduit 212 which may be used in the aftertreatment system 100, according to a particular embodiment. The reductant delivery conduit 212 comprises a reductant delivery conduit first portion 215 configured to be fluidly coupled to a reductant storage tank (e.g., the reductant storage tank 110). A reductant delivery conduit second portion 217 is located downstream of the reductant delivery conduit first portion 215 and is configured to be fluidly coupled to a connector of a reductant insertion assembly (e.g., the reductant insertion assembly 120). A reductant delivery conduit connector 214a fluidly couples the reductant delivery conduit first portion 215 to the reductant delivery conduit second portion 217 and has a bend 214 provided therein.

In various arrangements, the reductant delivery conduit connector 214a may have a cross-sectional thickness greater than a cross-sectional thickness of the reductant delivery conduit first portion 215 and the reductant delivery conduit second portion 217 and/or formed from a stronger material. This may allow the reductant delivery conduit connector 214a to have a higher load bearing capability relative to the reductant delivery conduit first portion 215 and the reductant delivery conduit second portion 217, so as to provide an even higher resistance to the force due to freezing and expansion of the reductant without increasing the thickness of the reductant delivery conduit first portion 215 and second portion 217. In still other embodiments, the reductant delivery conduit connector 214a may including coupling features or otherwise a coupling mechanism (e.g., threads, a snap-fit mechanism, grooves, indents, detents, etc.) configured to the allow the connector (e.g., the connector 122 of the reductant insertion assembly 120) to be directly coupled thereto such that the reductant delivery conduit second portion 217 may be excluded.

As shown in FIG. 1, the reductant delivery conduit 112 includes a single bend 114. In other embodiments, a reductant delivery conduit may include a plurality of bends. For example, FIG. 2B is a schematic illustration of a reductant delivery conduit 312 which may be used in the aftertreatment system 100, according to another embodiment. The reductant delivery conduit 312 comprises a first bend 314a provided along a length of the reductant delivery conduit 312, and structured to orient a portion of the reductant delivery conduit 312 perpendicular to a flow axis of a reductant delivery conduit first portion 315 upstream of the first bend 314a. A second bend 314b is positioned downstream of the first bend 314a. The second bend 314b is structured to orient a reductant delivery conduit second portion 317 downstream of the second bend 314b in a direction parallel to, and in the same direction as the flow axis of the reductant delivery conduit first portion 315. In other embodiments, the reductant delivery conduit second portion 317 may be oriented parallel to and in an opposite direction to the reductant delivery conduit first portion 315 flow axis.

FIG. 2C is a schematic illustration of a reductant delivery conduit 412, according to yet another embodiment. The reductant delivery conduit 412 comprises a first bend 414a provided along a length of the reductant delivery conduit 412 and structured to orient a portion of the reductant delivery conduit 412 perpendicular to a flow axis of a reductant delivery conduit first portion 415 upstream of the first bend 414a. A second bend 414b is positioned downstream of the first bend 414a and structured to orient a portion of the reductant delivery conduit 412 downstream of the second bend 414b parallel to and in an opposite direction of the flow axis of the reductant delivery conduit first portion 415. A third bend 414c is positioned downstream of the second bend 414b and structured to orient a portion of the reductant delivery conduit 412 downstream of the third bend 414c in a direction perpendicular to the flow axis of the reductant delivery conduit first portion 415 away therefrom. Furthermore, a fourth bend 414d is positioned in the reductant delivery conduit 412 downstream of the third bend 414c and structured to orient a reductant delivery conduit second portion 417 downstream of the fourth bend 414d parallel to and in the same direction as the flow axis of the reductant delivery conduit first portion 415.

It should be appreciated that while FIGS. 1 and 2A-2C show particular embodiments of reductant delivery conduits 312, 412, in other embodiments, a reductant delivery conduit may have any number of bends oriented in any suitable direction. Moreover, while FIGS. 1 and 2A-2C show sharp bends, in various embodiments, a reductant delivery conduit may have a curved or angled portion defining the bend.

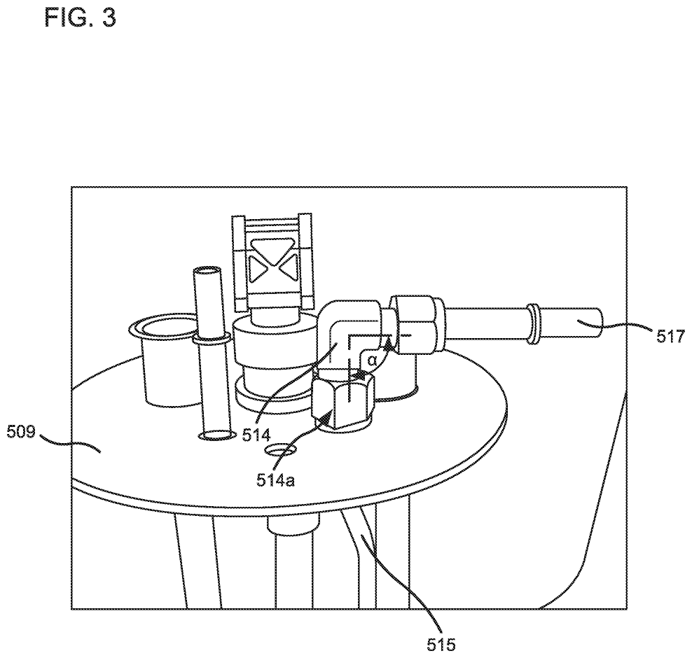

FIG. 3 is a top perspective view of a reductant storage tank cap 509 (e.g., a header) of a reductant a reductant storage tank (e.g., the reductant storage tank 110). A reductant delivery conduit first portion 515 is positioned through the reductant storage tank cap 509 (e.g., positioned through an opening defined in the reductant storage tank cap 509. A reductant delivery conduit connector 514a is coupled to an end of the reductant delivery conduit first portion 515. The reductant delivery conduit connector 514a is positioned outside the reductant storage tank (e.g., the reductant storage tank 110) to which the reductant storage tank cap 509 is coupled. The reductant delivery conduit connector 514a defines a bend 514 having a bend angle α which is about 90 degrees. A reductant delivery conduit second portion 517 is also coupled to the reductant delivery conduit connector 514a and is configured to be coupled to a connector of a reductant insertion assembly (e.g., the connector 122). The reductant delivery conduit connector 514a may be formed from the same material as the reductant delivery conduit first portion 515 and second portion 517 (e.g., stainless steel or aluminum) but may have a larger thickness than a thickness of each of the reductant delivery conduit first portion 515 and second portion 517 as shown in FIG. 3.

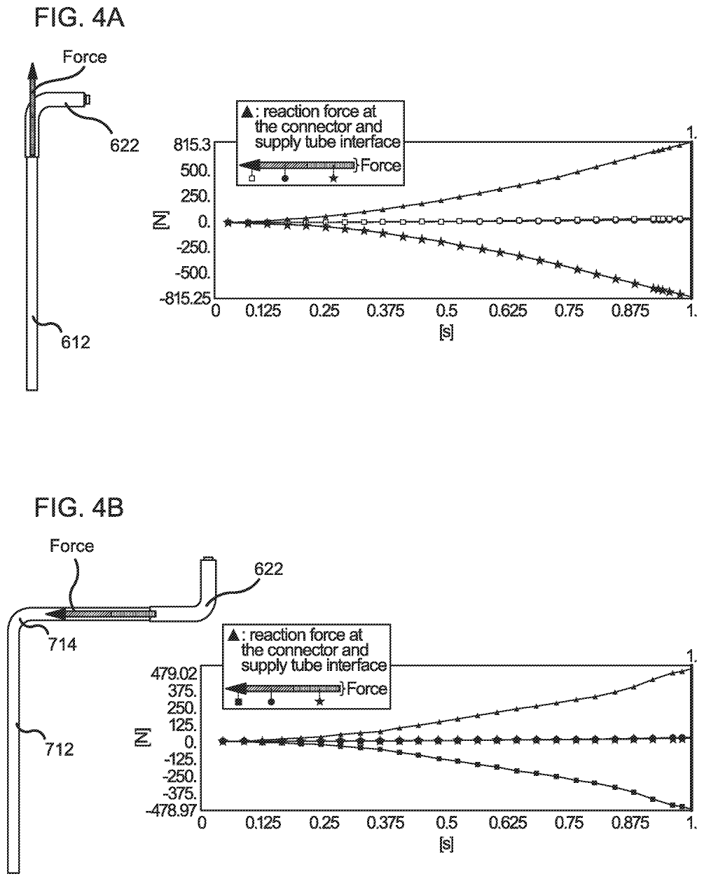

FIG. 4A shows a conventional straight reductant delivery conduit 612 coupled to a connector 622 of a reductant insertion assembly 120, and a plot of the force exerted at an interface between the straight reductant delivery conduit 612 and the connector 622 due to the freezing of the reductant in the straight reductant delivery conduit 612 and a reductant storage tank (not shown) coupled thereto. As observed from the plot, the maximum force exerted at the interface is 819 N which may be sufficient to damage (e.g., crack) the connector 622.

FIG. 4B shows a reductant delivery conduit 712 with a bend 714 having a bend angle of 90 degrees provided therein. The reductant delivery conduit 712 is coupled to the connector 622. FIG. 4B also shows a plot of the force exerted at an interface between the bent reductant delivery conduit 712 and the connector 722 due to the freezing of the reductant in the reductant delivery conduit 712 and a reductant storage tank (not shown) coupled thereto. As observed from the plot, the maximum force exerted at the interface is 479 N. Therefore the bent reductant delivery conduit 712 provides about a 1.7 times reduction in force due to freezing and expansion of the reductant therein, relative to the straight reductant delivery conduit 612 having no bends.

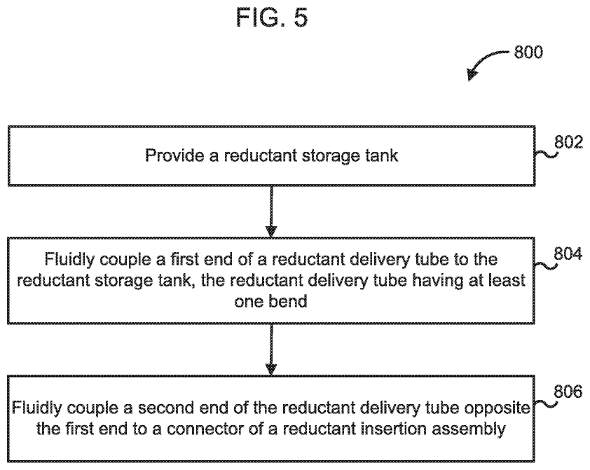

FIG. 5 is a schematic illustration of a method 800 for reducing a force exerted due to freezing and expansion of a reductant in a reductant delivery conduit (e.g., the reductant delivery conduit 112), according to an embodiment. The method 800 comprises providing a reductant storage tank, at 802. For example, the reductant storage tank 110 is provided.

At 804, a first end a reductant delivery conduit is fluidly coupled to the reductant storage tank. The reductant delivery conduit has at least one bend provided therein. For example, the first end 111 of the reductant delivery conduit 112, or any other reductant delivery conduit (e.g., reductant delivery conduit 212, 312, 412, 512) is fluidly coupled to the reductant storage tank 110 (e.g., a through a reductant storage tank cap such as the reductant storage tank cap 509 of the reductant storage tank 110). The reductant delivery conduit (e.g., the reductant delivery conduit 112) may include a single bend (e.g., the single bend 114), or may include a plurality of bends (e.g., the reductant delivery conduit 312, 412). In other embodiments, the bend may be provided in a reductant delivery conduit connector (e.g., the reductant delivery conduit connector 214a, 514a) coupled to a reductant delivery conduit first portion (e.g., the reductant delivery conduit first portion 215), and a reductant delivery conduit second portion (e.g., the reductant delivery conduit second portion 217). The bend angle may be in a range of 80-100 degrees (e.g., 90 degrees).

At 806, a second end of the reductant delivery conduit is fluidly coupled to a connector of a reductant insertion assembly. For example, the second end 113 of the reductant delivery conduit 112 or any other reductant delivery conduit described herein is fluidly coupled to the connector 122, 622 of the reductant insertion assembly (e.g., the reductant insertion assembly 120). The bend causes a reduction in a force exerted by expansion and freezing of a reductant in the reductant delivery conduit and/or the reductant storage tank, as previously described herein.

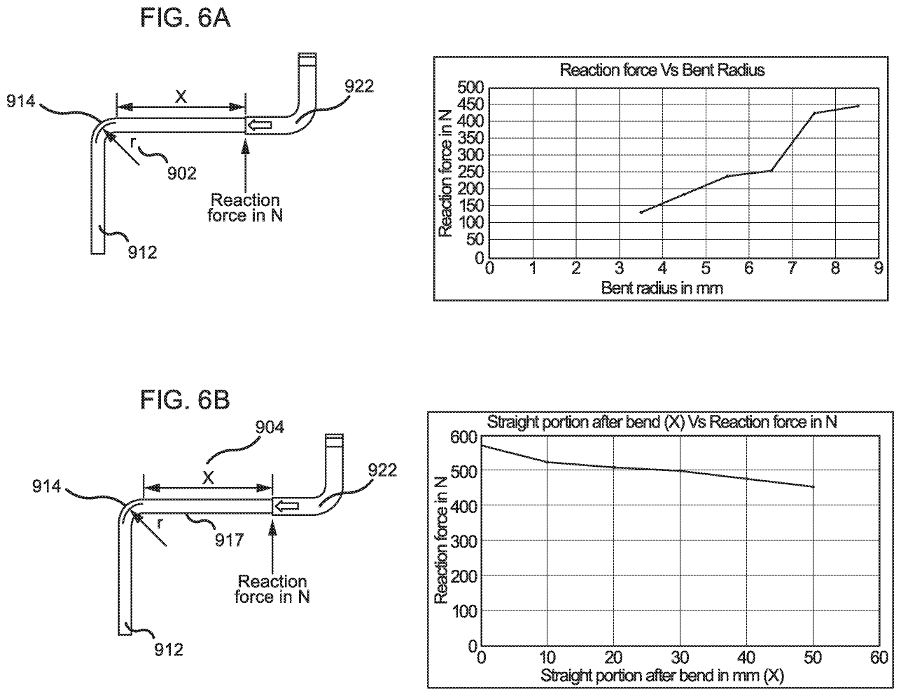

FIG. 6A shows a reductant delivery conduit 912 having a bend 914 provided therein. The reductant delivery conduit 912 is coupled to a connector 922 of a reductant insertion assembly 120. FIG. 6A also shows a graph of the reaction force vs. bend radius The bend radius 902 can define a radius of curvature of the bend 914. As observed from the plot, as the bend radius decreases, the reaction force (or the force exerted at the interface between the bent reductant delivery conduit 912 and the connector 922) decreases. The bend radius 902 can be between 3.5 and 6.5 mm, preferably between 3.5 and 5.5 mm or more preferably between 3.5 and 4.5 mm.

FIG. 6B shows a reductant delivery conduit 912 having a bend 914 provided therein. The reductant delivery conduit 912 is coupled to a connector 922 of a reductant insertion assembly 120. FIG. 6B also shows a graph of the reaction force vs. length 904 of a reductant delivery conduit second portion 917. As observed from the plot, as the length 904 of the reductant delivery conduit second portion 917 increases, the reaction force (or the force exerted at the interface between the bent reductant delivery conduit 912 and the connector 922) decreases. The reductant delivery conduit second portion 917 can be between 20 and 50 mm, preferably between 30 and 50 mm or more preferably between 40 and 50 mm.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled” and the like as used herein mean the joining of two members directly or indirectly to one another. Such joining may be stationary (e.g., permanent) or movable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements; values of parameters, mounting arrangements; use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes, and omissions may also be made in the design, operating conditions, and arrangement of the various exemplary embodiments without departing from the scope of the present application.

While this specification contains many specific implementation details, these should not be construed as limitations on the scope of any embodiments or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An apparatus for use in an aftertreatment system comprising:
a reductant storage tank configured to store a reductant; and
a reductant delivery conduit comprising:
a first end fluidly coupled to the reductant storage tank,
a second end opposite the first end, the second end configured to be fluidly coupled to a connector of a reductant insertion assembly, and
at least one bend provided in the reductant delivery conduit along a length thereof, the at least one bend being configured to inhibit failure at an interface between the second end of the reductant delivery conduit and the connector of the reductant insertion assembly due to freezing of a reductant in the reductant delivery conduit.

2. The apparatus of claim 1, wherein the reductant delivery conduit comprises:
a reductant delivery conduit first portion fluidly coupled to the reductant storage tank at the first end;
a reductant delivery conduit second portion configured to be fluidly coupled to the connector at the second end; and
a reductant delivery conduit connector fluidly coupling the reductant delivery conduit first portion to the reductant delivery conduit second portion, the reductant delivery conduit connector comprising the at least one bend.

3. The apparatus of claim 2, wherein a cross-sectional thickness of the reductant delivery conduit connector is greater than a cross-sectional thickness of the reductant deliver conduit.

4. The apparatus of claim 2, wherein a length of the reductant delivery conduit first portion is greater than a length of the reductant delivery conduit second portion.

5. The apparatus of claim 1, wherein the reductant delivery conduit includes exactly one bend.

6. The apparatus of claim 1, wherein a bend angle of the at least one bend is in a range of 80 degrees to 100 degrees.

7. The apparatus of claim 1, wherein the at least one bend comprises a plurality of bends.

8. The apparatus of claim 1, wherein the at least one bend is monolithically formed in the reductant delivery conduit.

9. The apparatus of claim 1, wherein the at least one bend has a bend radius of less than 8.5 mm.

10. The apparatus of claim 1, wherein a length of the reductant delivery conduit between the at least one bend of the reductant delivery conduit and the second end of the reductant delivery conduit is greater than 10 mm.

11. A method for preventing failure in an aftertreatment system comprising:
providing a reductant storage tank configured to store a reductant; and
providing a reductant delivery conduit comprising at least one bend provided in the reductant delivery conduit along a length thereof;
coupling a first end the reductant delivery conduit to the reductant storage tank; and
coupling a second end of the reductant delivery conduit to a connector of a reductant insertion assembly,
wherein the at least one bend is configured to inhibit failure at an interface between the second end of the reductant delivery conduit and the connector of the reductant insertion assembly due to freezing of a reductant in the reductant delivery conduit.

12. The method of claim 11, wherein the reductant delivery conduit further comprises:
a reductant delivery conduit first portion fluidly coupled to the reductant storage tank via the first end when the first end of the reductant delivery conduit is coupled to the reductant storage tank;
a reductant delivery conduit second portion fluidly coupled to the connector via the second end when the second end of the reductant delivery conduit is coupled to the connector of the reductant insertion assembly; and
a reductant delivery conduit connector fluidly coupling the reductant delivery conduit first portion to the reductant delivery conduit second portion, the at least one bend being provided in the reductant delivery conduit connector.

13. The method of claim 12, wherein a cross-sectional thickness of the reductant delivery conduit connector is greater than a cross-sectional thickness of the reductant deliver conduit.

14. The method of claim 12, wherein a length of the reductant delivery conduit first portion is greater than a length of the reductant delivery conduit second portion.

15. The method of claim 11, wherein the reductant delivery conduit includes exactly one bend.

16. The method of claim 11, wherein a bend angle of the at least one bend is in a range of 80 degrees to 100 degrees.

17. The method of claim 11, wherein the at least one bend comprises a plurality of bends.

18. The method of claim 11, wherein the at least one bend is monolithically formed in the reductant delivery conduit.

19. The method of claim 11, wherein the at least one bend has a bend radius of less than 8.5 mm.

20. The method of claim 11, wherein a length of the reductant delivery conduit between the at least one bend of the reductant delivery conduit and the second end of the reductant delivery conduit is greater than 10 mm.
